(19) United States
(12) Patent Application Publication
(10) Pub. No.: US 2017/0064220 A1
(43) Pub. Date: Mar. 2, 2017

(54) Hyperspectral/Multispectral Imaging Direct Push Probe

(71) Applicant: United States Government as represented by the Secretary of the Navy, San Diego, CA (US)

(72) Inventors: Pamela A. Boss, San Diego, CA (US); Michael D. Putnam, San Diego, CA (US); Gregory W. Anderson, San Diego, CA (US)

(21) Appl. No.: 14/834,684

(22) Filed: Aug. 25, 2015

(51) Int. Cl. H04N 5/33; G03B 11/00; H04N 5/372; E21B 47/00; H04N 5/225

(52) U.S. Cl. CPC H04N 5/332; E21B 47/0002; H04N 5/2256; H04N 5/372; G03B 11/00; H04N 2005/2255

(57) ABSTRACT

An apparatus comprising: a probe configured to be pushed into a subsurface soil environment; a transparent window mounted to a side of the probe; a broad-spectrum light source mounted within the probe and positioned such that when the light source is activated broad-spectrum light exits the window; a tunable optical filter mounted within the probe and positioned so as to receive, as an input, light reflected back through the window from the subsurface soil environment, wherein the filter comprises a plurality of settings at each of which the filter is configured to output light within a given wavelength range to the exclusion of other wavelength light ranges; and an imaging system disposed within the probe and configured to capture an image of the output light from the filter at each of the settings at a given depth of the probe in the subsurface soil environment.

### FEDERALLY-SPONSORED RESEARCH AND DEVELOPMENT

The United States Government has ownership rights in this invention. Licensing and technical inquiries may be directed to the Office of Research and Technical Applications, Space and Naval Warfare Systems Center, Pacific, Code 72120, San Diego, Calif., 92152; voice (619) 553-5118; ssc_pac_t2@navy.mil. Reference Navy Case Number 102543.

### BACKGROUND OF THE INVENTION

Geochemical and microbiological conditions vary tremendously over small distances in the Earth's subsurface and these variations are not captured well by current site characterization technologies. Better characterization techniques at smaller scales are needed.

### SUMMARY

Disclosed herein is an apparatus comprising, consisting of, or consisting essentially of a direct push probe, a transparent window, a broad-spectrum light source, a tunable optical filter, and an imaging system. The direct push probe is configured to be pushed into a subsurface soil environment. The transparent window is mounted to a side of the probe. The broad-spectrum light source is mounted within the probe and positioned such that when the light source is activated broad-spectrum light exits the window. The tunable optical filter is mounted within the probe and positioned so as to receive, as an input, light reflected back through the window from the subsurface soil environment. The tunable optical filter comprises a plurality of settings. For each setting, the tunable optical filter is configured to output light within a given wavelength range to the exclusion of other wavelength light ranges. The imaging system is disposed within the probe and configured to capture an image of the output light from the tunable optical filter at each of the settings at a given depth of the probe in the subsurface soil environment so as to provide in-situ hyperspectral imaging of the subsurface soil environment at the given depth.

The apparatus disclosed herein may be used to acquire hyperspectral images by practicing the following steps. The first step provides for penetrating a subsurface soil environment to a given depth with a direct push probe. The next step provides for illuminating through a window in the probe the subsurface soil adjacent to the probe at the given depth with broad-spectrum light. The next step provides for receiving, with a tunable optical filter, light reflected back through the window from the subsurface soil environment at the given depth. The next step provides for sequentially stepping through a plurality of filter settings, wherein for each setting the tunable optical filter is configured to output light within a given wavelength range to the exclusion of other wavelength light ranges. The next step provides for capturing an image of the output light from the tunable optical filter at each of the settings so as to provide in-situ hyperspectral imaging of the subsurface soil environment at the given depth.

The multispectral imaging method disclosed herein may also be described as comprising the following steps. The first step provides for penetrating a subsurface soil environment to a given depth with a direct push probe. The next step provides for illuminating through a window in the probe the subsurface soil adjacent to the probe at the given depth with broad-spectrum light. The next step provides for receiving, with a tunable optical filter, light reflected back through the window from the subsurface soil environment at the given depth. The next step provides for sequentially stepping through a plurality of filter settings, wherein for each setting the tunable optical filter is configured to output light within a given wavelength range to the exclusion of other wavelength light ranges. The next step provides for capturing an image of the output light from the tunable optical filter at each of the settings so as to provide in-situ multispectral imaging of the subsurface soil environment at the given depth.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Throughout the several views, like elements are referenced using like references. The elements in the figures are not drawn to scale and some dimensions are exaggerated for clarity.

FIG. 1A is a cross-sectional side view of an embodiment of an imaging probe.

FIG. 1B is a front view of a transparent window and light source.

FIG. 2 is a side-view illustration of a cone penetrometer truck utilizing an imaging probe.

FIG. 3 is a plot showing reflectance spectra of minerals.

FIG. 4A is a real color image of the soil profile of a soil core sample.

FIGS. 4B-4D are false-color images of a soil core sample.

FIG. 5 is a cross-sectional side view of an embodiment of an imaging probe.

FIG. 6 is a flowchart of a multispectral/hyperspectral imaging method.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

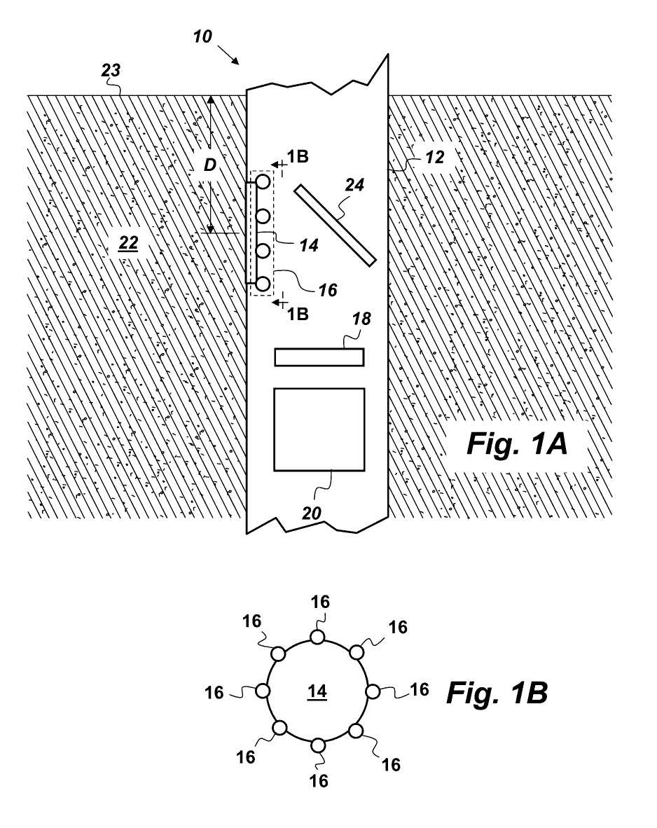

FIG. 1A is a cross-sectional, side view of an embodiment of an imaging probe 10 that comprises, consists of, or consists essentially of a direct push probe 12, a transparent window 14, a broad-spectrum light source 16, a first tunable optical filter 18, and a first imaging system 20. The direct push probe 12 is configured to be pushed into a subsurface soil environment 22. The transparent window 14 may be mounted to a side of the probe 12. FIG. 1B is a front view of the window 14 and the broad-spectrum light source 16. The broad-spectrum light source 16 may be mounted within the probe 12 and positioned such that when the light source 16 is activated broad-spectrum light exits the window 14 (i.e., propagates toward the subsurface soil environment 22 outside the probe 12). The first tunable optical filter 18 may be mounted within the probe 12 and positioned so as to receive, as an input, light reflected back through the window 14 from the subsurface soil environment 22. The first tunable optical filter 18 comprises a plurality of settings. For each setting, the first tunable optical filter 18 is configured to output light within a given wavelength range to the exclusion of other wavelength light ranges. The first imaging system 20 may be disposed within the probe 12 and configured to capture an image of the output light from the first tunable optical filter 18 at each of the settings at a given depth D of the probe 12 in the subsurface soil environment 22 so as to provide in-situ hyperspectral and/or multispectral imaging of the subsurface soil environment 22 at the given depth D from a soil surface 23. The imaging probe 10 may further comprise a mirror 24 positioned so as to direct light reflected off the subsurface soil environment 22 to the first tunable optical filter 18.

The push probe 12 may be any probe capable of being pushed into the subsurface soil environment 22. The push probe 12 may be any desired size or shape. A suitable example of the push probe 12 includes, but is not limited to, a cone penetrometer such as is used in cone penetration testing (CPT).

The window 14 may be made of any transparent material capable of transmitting broad spectrum light. As used herein, the phrase “broad spectrum” means having a wavelength range of at least 500 nanometers (nm) spanning from visible (VIS) to infrared (IR) regions of the electromagnetic spectrum. Suitable examples of the transparent window 14 include, but are not limited to, windows made of sapphire, UV grade fused silica, and quartz. Sapphire is scratch resistant and has a transmission range of 150-5000 nm. The window 14 may be attached to a side of the push probe 12 by any suitable means. In one example embodiment, the window 14 is epoxied to a window housing in the side of the push probe 12.

The broad spectrum light source 16 may be a single light source with broad spectrum light output capabilities or the broad spectrum light source 16 may comprise or consist of a plurality of individual light sources. For example, the broad spectrum light source 16 may consist of a plurality of light emitting diodes (LEDs), where each LED emits light in a different spectral range, such that, together, the light from the plurality of LEDs ranges from visible (VIS) to infrared (IR).

The first tunable optical filter 18 may be any optical filter capable of receiving incoming light and then being tuned to output light within a given wavelength range to the exclusion of other wavelength light ranges that are present in the incoming light. Suitable examples of the first tunable optical filter 18 include, but are not limited to an acousto-optic modulator, and a liquid crystal tunable filter that uses electronically controlled liquid crystal elements to transmit a desired wavelength range. Rather than using a dispersive element and multiple detector arrays as is traditionally done in multispectral/hyperspectral imaging to break an image into its constituent spectral colors, the imaging probe 10 utilizes the tunable optical filter 18 to output light within a given wavelength range to the exclusion of other wavelength light ranges. In other words, the first tunable optical filter 18 is configured to transmit a selectable wavelength light range to the exclusion of other wavelength light ranges. The tunable optical filter 18 may be placed between the mirror 24 and the imaging system 20. Two types of commercially available solid-state tunable filters that are suitable examples of the first tunable optical filter 18 include, but are not limited to, an Acousto Optic Tunable Filter (AOTF) and a Liquid Crystal Tunable Filter (LCTF). The AOTF is based upon the principles of the acousto-optic modulator. For TeO₂-based AOTF's, the spectral range is 450-4000 nm. The LCTF uses electronically controlled liquid crystal elements to transmit the desired wavelength range within the spectral range 400-2450 nm.

The first imaging system 20 may be any imaging system capable of recording color images of the subsurface soil environment 22. A suitable example of the first imaging system 20 is, but is not limited to, a charge-coupled device (CCD) camera. The first imaging system 20 may comprise a lens/focusing system to focus and magnify the light reflected off the subsurface soil environment 22. The first imaging system 20 is configured to convert the light coming out of the first tunable optical filter 18 into an electronic image. Standard CCD cameras cover the spectral range between 320-1000 nm. There are also commercially available CCD cameras that are more sensitive to the near IR (700-1100 nm).

The imaging probe 10 may be used in any subsurface soil environment 22 that the push probe 12 may be pushed into. For example, the push probe 12 may be pushed into subsurface soil environments 22 comprising clays, sand, and sediment. Rocks can cause problems (break the window or keep one from pushing the probe 12 to a desired depth). Thus, rocky subsurface soil environments are not desirable.

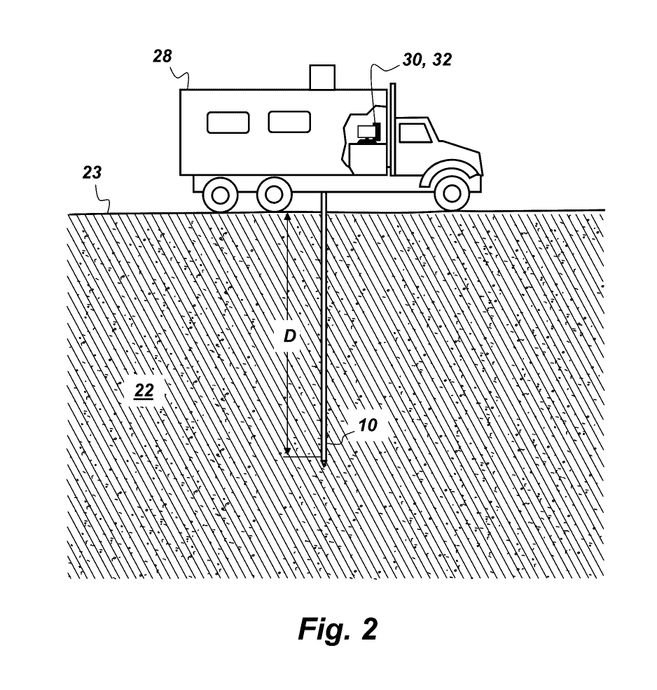

FIG. 2 is a side view illustration of an embodiment of the imaging probe 10 where the imaging probe 10 is integrated into a cone penetrometer. In FIG. 2, a CPT truck 28 is shown parked on the surface 23 at a given location where the imaging probe 10 has been driven into the subsurface soil environment 22 to depth D. The imaging probe 10 may optionally comprise a global positioning system (GPS) sensor 30 and a depth sensor 32. In the embodiment of the imaging probe 10 shown in FIG. 2, the GPS sensor 30 and the depth sensor 32 are mounted within the CPT truck 28. From its position at depth D, the imaging probe 10 is configured to obtain hyperspectral and/or multispectral imaging of the subsurface soil environment 22. These images can be used to assess biogeochemical conditions in the soil profile as a function of depth. The imaging probe 10 may be used to obtain hyperspectral and/or multispectral imaging at any desired depth, limited by only by the probe 12′s depth capability. For example, the probe 12 may be pushed to depths exceeding 2 meters. In some cases, the probe may be pushed to depths exceeding 60 meters.

A multispectral image is one that captures image data at specific wavelengths across the electromagnetic spectrum. Spectral imaging with more numerous bands, finer spectral resolution or wider spectral coverage is referred to as hyperspectral. The hyperspectral imaging performed by the imaging probe 10 does not use air- or space-borne sensors. Soils are a heterogeneous, polyphasic combination of solid mineral and organic constituents, liquid, and gas. Consequently, each surface has its own spectral reflectance due to its chemical composition and can therefore be discriminated by its spectral reflectance. The reflectance of soils depends on the soil color, the mineral composition, organic matter content, soil texture, soil moisture and the surface characteristics (roughness, stoniness). Some characteristics lead to an overall decrease in reflectance, and others absorb radiation at specific wavelengths.

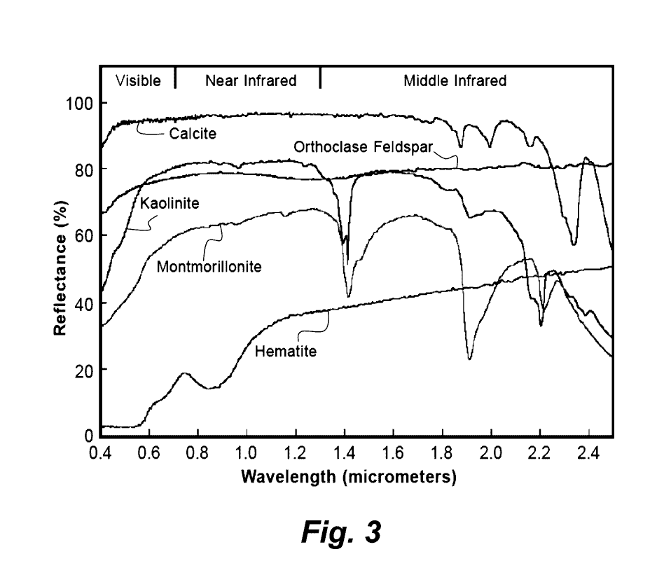

FIG. 3 is a plot showing examples of reflectance spectra taken of different minerals that comprise soils. The most striking, visible difference of different soils is the color. In the spectral reflectance of soil the most prominent feature is the high variation in brightness in the visible part of the electromagnetic spectrum. The reflectance curves also vary in shape, due to their content of iron oxides and organic material, leading to different color appearances. Mineralogical components such as iron oxides, clay minerals and carbonates are detectable with remote sensing methods, due to the interaction of the solar radiation with the molecule structures. Iron oxides have broad absorption features in the visible part of the spectrum at 0.45 μm, 0.6 μm and 0.9 μm. Clay minerals have distinct absorption features around 2.2 μm. Carbonates show narrow absorption features at 2.3 μm of the reflectance spectrum. Besides influencing the color of the soil, the organic material usually darkens the spectral reflectance in the entire spectral range from 0.4-2.5 μm. An increase in the content of organic material leads to a decrease in the intensity of the reflectance spectrum. This results in different shapes of the spectral reflectance curve depending on the content of organic material of the sample.

The imaging probe 10 does not characterize the ground surface 23, such as is done in the prior art, but instead is able to measure the inherent vertical heterogeneity of soil profiles. Soil generally consists of visually and texturally distinct layers referred to as ‘soil horizons.’ Besides being heterogeneous, many soil horizons show clear patterns with widely varying physical and chemical properties on small spatial scales that will ultimately determine the fate of contaminants. The movement of contaminants through the subsurface is complex and is difficult to predict. Different types of contaminants react differently with soils, sediments, and other geologic materials and commonly travel along different flowpaths and at different velocities. Hyperspectral imaging of a soil profile provides information on the hydrogeological and biochemical properties of the subsurface soil environment 22. These properties, in turn, influence the flow and transport of contaminants, their natural attenuation, and contaminant remediation efficacy. Consequently, hyperspectral imaging of the soil profile may be used to do fine-scale delineation of contaminated subsurface environments.

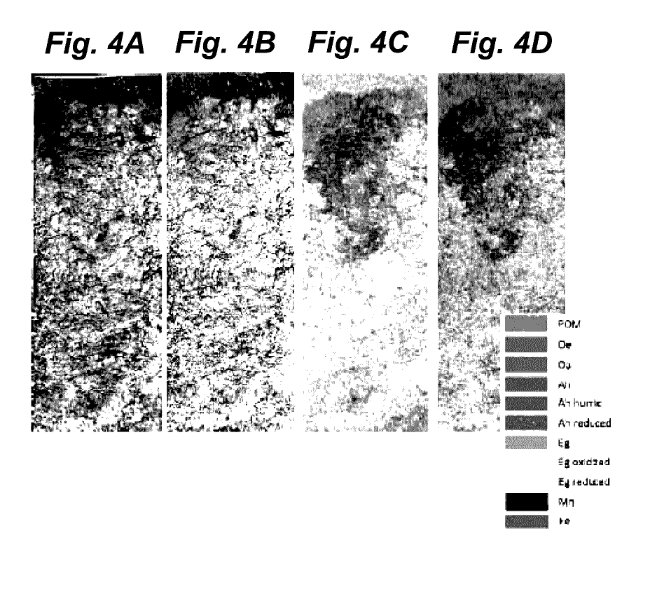

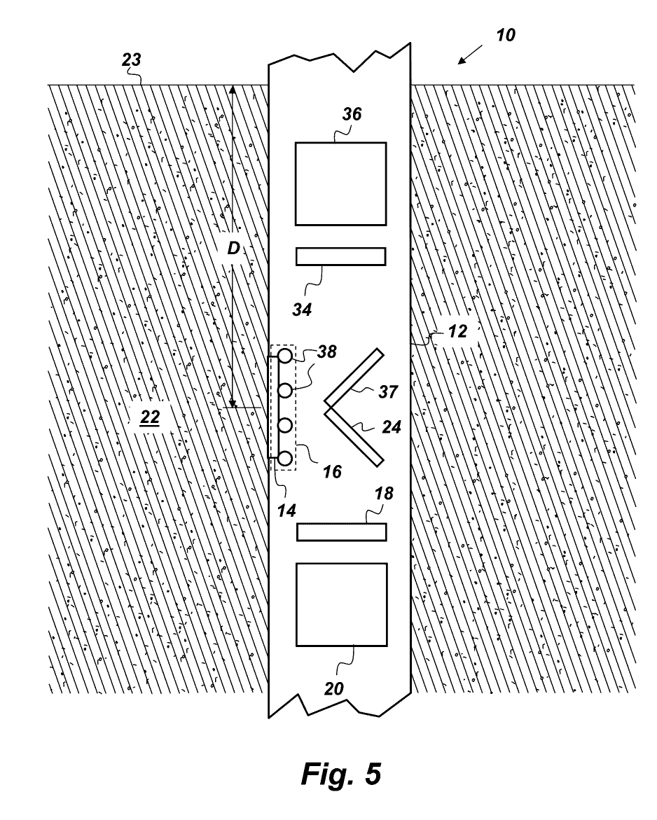

FIG. 4A shows the real color depiction of the soil profile of a vertical 10 cm×30 cm soil core sample. FIGS. 4B-4D show false-color composites and the classification result of hyperspectral imaging of the soil core where 160 spectral bands were recorded in the spectral range of 410-990 nm. The different soil horizons (layers), particulate organic matter (POM), iron and manganese inclusions, and oxidized/reduced areas may be well discriminated. The hyperspectral images of a soil profile obtained by the imaging probe 10 may be used for various characterizations of the soil like horizon classification, mapping the chemical composition, or analyzing the small-scale heterogeneity. FIGS. 4A-4D show that the spectral range between 410-990 nm provides considerable information on the chemical composition and heterogeneity of the soil. Given what is currently commercially available, to cover the spectral range of 410-990 nm, two separate versions of the imaging probe 10 may be used—one that covers the 400-700 nm spectral range and the other the 700-1100 nm spectral range. The 400-700 nm embodiment of the imaging probe 10 uses white LEDs for the light source 16, a tunable optical filter 18 that is operable in the 400-700 nm spectral range, and a standard CCD camera for the imaging system 20. The 700-1100 nm embodiment of the imaging probe 10 uses a mix of near IR LEDs that together emit between 700-1100 nm for the light source 16, a tunable optical filter 18 that is operable in the 700-1100 nm spectral range, and a near IR CCD camera for the imaging system 20. Alternatively, a single imaging probe 10, such as is shown in FIG. 5, may be used to cover the spectral range of 410-990 nm.

FIG. 5 is a cross-sectional, side view illustration of an alternative embodiment of the imaging probe 10 that uses a single probe to cover the 410-990 nm spectral range. The embodiment of the imaging probe 10 shown in FIG. 5 further comprises a second tunable optical filter 34, a second imaging system 36, and a second mirror 37 designed to operate in a different wavelength range than the first tunable optical filter 18 and the first imaging system 20. The following description is of a specific example of the embodiment of the imaging probe shown in FIG. 5, but it is to be understood that the following is merely offered as an example embodiment. In an example embodiment of the imaging probe 10, the light source 16 comprises a combination of LEDs 38 that covers the spectral range from about 400 nm to about 1100 nm. Specifically, in the example embodiment, the light source 16 consists of a ring of six LEDs 38. Three of the LEDs are white light LEDs having operational wavelengths within the range of 425-700 nm. The other three LEDs are IR LEDs that operate in the near IR/IR spectral range between 780-4000 nm. The spectral range of the imaging probe 10 may be changed by tuning or changing the spectral range of the light source 16. When LEDs are used as the light source 16, the extent of the spectral range of the imaging probe 10 depends upon the center wavelength and full width at half maximum (FWHM) specifications of the LEDs.

In the example embodiment, the first tunable optical filter 18 is operable in the 400-700 nm spectral range, and the first imaging system 20 is a standard CCD camera that is designed for operating in the spectral range between 320-1000 nm. In the example embodiment, the second tunable optical filter 34 is operable in the 700-1100 nm spectral range, and the second imaging system 36 is a CCD camera that is designed for operating in the near IR spectral range (700-1100 nm). In the example embodiment, light from the light source 16 that is reflected off of the subsurface soil environment 22 that is visible through the window 14 is received by mirrors 24 and 37. Mirror 24 directs the received light to the first tunable optical filter 18. The second mirror 37 directs the received light to the second tunable optical filter 34. The second tunable optical filter 34 receives the light from the second mirror 37 and then filters out all the light except the light in a limited wavelength range (e.g., a wavelength range that corresponds to a particular color) according to a first setting. The first-setting-filtered light is then received by the second imaging system 36 where an image is recorded. This process repeats for each setting of the second tunable optical filter 34.

The imaging probe 10 can do in-situ multispectral/hyperspectral imaging of a soil profile in real-time and provides visual and physiochemical data with high vertical and horizontal spatial resolution necessary to determine the biogeochemical and hydrogeological processes that are occurring in the subsurface soil environment 22. The data is obtained at spatial scales commensurate with the distribution of contaminants. Real-time in-situ imaging by the imaging probe 10 provides information on chemical composition that may be used for rapid delineation of archeological sites. Real-time in situ video images provided by the imaging probe 10 may be used to directly locate and map features such as shell beds, charcoal layers and unique lithology units associated with human habitation and/or and particular archeological site.

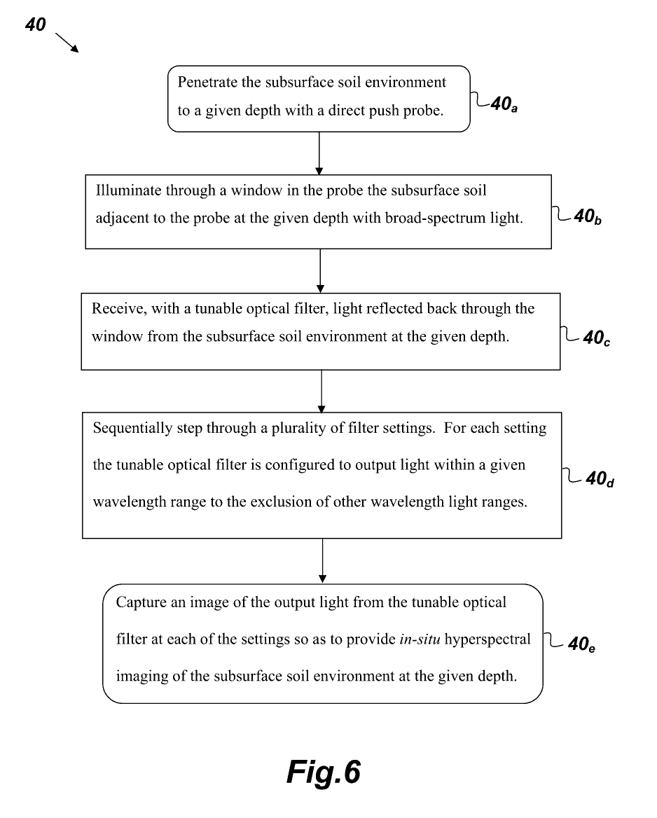

FIG. 6 is a flowchart of a hyperspectral imaging method 40 utilizing the imaging probe 10 comprising the following steps. The first step 40ₐ provides for penetrating a subsurface soil environment to a given depth with a direct push probe. The next step 40_{b} provides for illuminating through a window in the probe the subsurface soil adjacent to the probe at the given depth with broad-spectrum light. The next step 40_{c} provides for receiving, with a tunable optical filter, light reflected back through the window from the subsurface soil environment at the given depth. The next step 40_{d} provides for sequentially stepping through a plurality of filter settings. For each setting, the tunable optical filter is configured to output light within a given wavelength range to the exclusion of other wavelength light ranges. The next step 40ₑ provides for capturing an image of the output light from the tunable optical filter at each of the settings so as to provide in-situ multispectral and/or hyperspectral imaging of the subsurface soil environment at the given depth. The imaging probe 10 may be pushed to a plurality of depths at a given location and a separate series of multispectral and/or hyperspectral images may be created at each depth. The multispectral/hyperspectral images may be used to characterize the soil's horizon classification, to map the chemical composition of the soil, and to analyze the small-scale heterogeneity of the soil at each depth.

From the above description of the imaging probe 10, it is manifest that various techniques may be used for implementing the concepts of the imaging probe 10 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that the imaging probe 10 is not limited to the particular embodiments described herein, but is capable of many embodiments without departing from the scope of the claims.

We claim:

1. An apparatus comprising:
a direct push probe configured to be pushed into a subsurface soil environment;
a transparent window mounted to a side of the probe;
a broad-spectrum light source mounted within the probe and positioned such that when the light source is activated broad-spectrum light exits the window;
a first tunable optical filter mounted within the probe and positioned so as to receive, as an input, light reflected back through the window from the subsurface soil environment, wherein the first tunable optical filter comprises a plurality of settings, and wherein for each setting the first tunable optical filter is configured to output light within a given wavelength range to the exclusion of other wavelength light ranges; and
a first imaging system disposed within the probe and configured to capture an image of the output light from the first tunable optical filter at each of the settings at a given depth of the probe in the subsurface soil environment so as to provide in-situ hyperspectral imaging of the subsurface soil environment at the given depth.

2. The apparatus of claim 1, further comprising a global positioning system (GPS) sensor and a depth sensor such that the hyperspectral imaging is correlated with the given depth and a given location.

3. The apparatus of claim 1, wherein the direct push probe is a cone penetrometer used in conjunction with cone penetration testing (CPT).

4. The apparatus of claim 1, wherein the probe is capable of being pushed to depths greater than two meters.

5. The apparatus of claim 1, wherein the broad-spectrum light source consists of a plurality of light emitting diodes (LEDs).

6. The apparatus of claim 5, wherein each LED in the plurality of LEDs emits light in a different spectral range, such that, together, the light from the plurality of LEDs ranges from visible (VIS) to infrared (IR).

7. The apparatus of claim 1, wherein the first imaging system is a charge-coupled device (CCD) camera.

8. The apparatus of claim 1, wherein the first tunable optical filter is an acousto-optic modulator.

9. The apparatus of claim 1, wherein the first tunable optical filter is a liquid crystal tunable filter that uses electronically controlled liquid crystal elements to transmit a desired wavelength range.

10. The apparatus of claim 6, wherein the first tunable optical filter operates in a first wavelength range and the first imaging system is configured to capture light in the first wavelength range, and wherein claim 6 further comprises:
a first mirror positioned to receive incoming light reflected back through the window from the subsurface soil environment and to reflect the incoming light to the first tunable optical filter;
a second mirror positioned to receive the incoming light;
a second tunable optical filter disposed within the probe, configured to receive the incoming light that is reflected off the second mirror, and configured to operate in a second wavelength range, wherein the first and second wavelength ranges correspond to different sections of the visible (VIS) to infrared (IR) spectral range, and wherein the second tunable optical filter comprises a plurality of settings and wherein for each setting the second tunable optical filter is configured to output light within a given wavelength range to the exclusion of other wavelength light ranges;
a second imaging system disposed within the probe and configured to capture an image of the output light in the second wavelength range from the second tunable optical filter at each of the second tunable optical filter's settings at the given depth; and
using the images from the first and second image systems to create an in-situ hyperspectral profile of the subsurface soil environment at the given depth.

11. A hyperspectral imaging method comprising the following steps:
penetrating a subsurface soil environment to a given depth with a direct push probe;
illuminating through a window in the probe the subsurface soil adjacent to the probe at the given depth with broad-spectrum light;
receiving, with a tunable optical filter, light reflected back through the window from the subsurface soil environment at the given depth;
sequentially stepping through a plurality of filter settings, wherein for each setting the tunable optical filter is configured to output light within a given wavelength range to the exclusion of other wavelength light ranges; and
capturing an image of the output light from the tunable optical filter at each of the settings so as to provide in-situ hyperspectral imaging of the subsurface soil environment at the given depth.

12. The method of claim 11, wherein the capturing step is performed with a charge-coupled device (CCD) camera.

13. The method of claim 11, wherein the broad-spectrum light spans from visible (VIS) to infrared (IR).

14. The method of claim 11, wherein the probe is pushed to a plurality of depths at a given location and wherein a separate series of hyperspectral images are created at each depth.

15. The method of claim 14, wherein the probe is pushed as deep as 30 meters below a soil surface.

16. The method of claim 11, wherein the penetration step is accomplished with cone penetration testing (CPT) equipment.

17. The method of claim 14, further comprising the steps of characterizing the soil's horizon classification, mapping the chemical composition of the soil, and analyzing small-scale heterogeneity of the soil at each depth.

18. A multispectral imaging method comprising the following steps:
penetrating a subsurface soil environment to a given depth with a direct push probe;
illuminating through a window in the probe the subsurface soil adjacent to the probe at the given depth with broad-spectrum light;
receiving, with a tunable optical filter, light reflected back through the window from the subsurface soil environment at the given depth;
sequentially stepping through a plurality of filter settings, wherein for each setting the tunable optical filter is configured to output light within a given wavelength range to the exclusion of other wavelength light ranges; and
capturing an image of the output light from the tunable optical filter at each of the settings so as to provide in-situ multispectral imaging of the subsurface soil environment at the given depth.

19. The method of claim 18, wherein the probe is pushed to a plurality of depths at a given location and wherein a separate series of multispectral images are created at each depth.

20. The method of claim 19, further comprising the steps of characterizing the soil's horizon classification, mapping the chemical composition of the soil, and analyzing small-scale heterogeneity of the soil at each depth.
